(19) United States
(12) Patent Application Publication
(10) Pub. No.: US 2024/0315293 A1
(43) Pub. Date: Sep. 26, 2024

(54) METHOD OF MAKING A POWDER EGG ANALOGUE

(71) Applicant: SOCIETE DES PRODUITS NESTLE S.A., Vevey (CH)

(72) Inventors: ISABEL FERNANDEZ FARRES, Barcelona (ES); EDWIN ALBERTO HABEYCH NARVAEZ, Lausanne (CH); LIONEL JEAN RENE BOVETTO, Lucens (CH)

(21) Appl. No.: 18/579,392

(22) PCT Filed: Jul. 15, 2022
(86) PCT No.: PCT/EP2022/069924

§ 371 Date: Jan. 15, 2024

(30) Foreign Application Priority Data
Jul. 16, 2021 (EP) 21186226.3

(51) Int. Cl. A23L 15/00; A23L 11/00

(52) U.S. Cl. CPC A23L 15/35; A23L 11/07

(57) ABSTRACT

The invention relates to a method of making an egg analogue powder, said method comprising heating a legume flour or legume protein concentrate to a temperature between 100 to 140° C., preferably to about 120° C., wherein the legume flour is preferably a soybean flour, and wherein the legume flour or legume protein concentrate after the heating step has a) a loss factor (tan δ) of between 0.1 and 0.2, a G′ of between 2000 to 8000 Pa, and a G″ of between 400 and 1500 Pa when measured at 8 wt % protein concentration, at a frequency of 1 Hz, strain of 0.5% and at 30° C. after heating a dispersion of the heated legume flour or legume protein concentrate to at least 95° C.; and b) a moisture content lower than 2.5%; and c) a water activity (aw) less than 0.6.

### INTRODUCTION

Egg powders are used in many sectors of the food industry since they are easy to handle in a safe manner, are not susceptible to bacterial growth, and can utilize precise water dosing in their formulation.

Egg powders provide consumers with advanced characteristics as well as technological advantages that are not found in liquid egg products. To compete with other functional ingredients, egg powder products are often specifically designed for customers' formulations, a technique greatly enhanced by the ingredient's diverse technical possibilities.

Demand for plant-based alternatives to egg products has grown significantly in recent years across many food categories and applications. This trend has been driven by many factors including allergenicity, sustainability, and consumer shifts towards flexitarian diets.

Plant-based egg alternatives are available in powder format. However, most egg analogue powders available commercially do not closely match the performance of real egg powders, for example in terms of appearance or rheology, and suffer the additional drawback that they are generally not affordable for many consumers.

### EMBODIMENTS OF THE INVENTION

The invention relates in general to a method of making an egg analogue, particularly an egg analogue powder, which addresses the abovementioned problems of prior art egg analogue powders.

In one embodiment, the method comprises heating a legume flour.

In one embodiment, the method comprises heating a legume protein concentrate.

In one embodiment, the legume flour or legume protein concentrate is heated to a temperature between 100 to 140° C.

Preferably, the legume flour or legume protein concentrate is heated to about 120° C.

Preferably, the legume flour is a soybean flour.

In one embodiment, said method comprises heating a legume flour or legume protein concentrate to a temperature between 100 to 140° C., preferably to about 120° C., wherein the legume flour is preferably a soybean flour.

In one embodiment, the legume flour or legume protein concentrate after the heating step has a loss factor (tan δ) of between 0.1 and 0.2, a G′ of between 2000 to 8000 Pa, and a G″ of between 400 and 1500 Pa when measured at 8 wt % protein concentration, at a frequency of 1 Hz, strain of 0.5% and at 30° C. after heating a dispersion of the heated legume flour or legume protein concentrate to at least 95° C.

In one embodiment, the legume flour or legume protein concentrate after the heating step has a moisture content lower than 2.5%.

In one embodiment, the legume flour or legume protein concentrate after the heating step has a water activity (aw) less than 0.8.

In one embodiment, the legume flour or legume protein concentrate after the heating step has a water activity (aw) less than 0.6.

In one embodiment, the legume flour or legume protein concentrate after the heating step has a
a. loss factor (tan δ) of between 0.1 and 0.2, a G′ of between 2000 to 8000 Pa, and a G″ of between 400 and 1500 Pa when measured at 8 wt % protein concentration, at a frequency of 1 Hz, strain of 0.5% and at 30° C. after heating a dispersion of the heated legume flour or legume protein concentrate to at least 95° C.; and
b. moisture content lower than 2.5%; and
c. water activity (aw) less than 0.6.

In one embodiment, the heating step has a duration of between 2 to 40 minutes.

In one embodiment, the legume flour before the heating step comprises between 15 to 35% fat.

In one embodiment, the legume flour before the heating step comprises between 30 to 50% protein.

In one embodiment, the legume flour after the heating step has a loss factor (tan δ) of 0.18, a G′ of between 2000 to 2500 Pa, and a G″ of between 400 and 800 Pa when measured at 8 wt % protein concentration, at a frequency of 1 Hz, strain of 0.5% and at 30° C. after heating a dispersion of the heated legume flour or legume protein concentrate to at least 95° C.

In one embodiment, the defatted legume flour before the heating step comprises less than 5% fat.

In one embodiment, the defatted legume flour before the heating step comprises between 40 and 60% protein.

In one embodiment, the defatted legume flour after the heating step has a loss factor (tan δ) of 0.19, a G′ of between 1000 to 1500 Pa, and a G″ of between 200 and 300 Pa when measured at 8 wt % protein concentration, at a frequency of 1 Hz, strain of 0.5% and at 30° C. after heating a dispersion of the heated legume flour to at least 95° C.

In one embodiment, the legume protein concentrate before the heating step comprises less than 5% fat.

In one embodiment, the legume protein concentrate before the heating step comprises between 45 to 70% protein.

In one embodiment, the flour after the heating step has a loss factor (tan δ) of 0.17, a G′ of between 300 to 500 Pa, and a G″ of between 50 and 100 Pa when measured at 8 wt % protein concentration, at a frequency of 1 Hz, strain of 0.5% and at 30° C. after heating a dispersion of the heated legume flour to at least 95° C.

In one embodiment, said method further comprises the steps
a. Adding water to the legume flour or legume protein concentrate, and mixing to form a hydrated flour or hydrated legume protein concentrate so that it has a moisture content of 10 to 25% before the heating step; and
b. Performing the heating step by heating the hydrated flour or hydrated legume protein concentrate to a temperature between 100° C. to 140° C., preferably for 30-40 minutes.

In one embodiment, the legume flour or legume protein concentrate after the heating step has a loss factor (tan δ) of between 0.15 and 0.2, a G′ of between 1000 to 4000 Pa, and a G″ of between 200 and 800 Pa when measured at 8 wt % protein concentration, at a frequency of 1 Hz, strain of 0.5% and at 30° C. after heating the dispersion to 95° C.; and a moisture content lower than 2.5%; and a water activity (aw) less than 0.6.

In one embodiment, the legume flour is defatted.

In one embodiment, the pH of the water is adjusted to between 7 to 8 by adding an alkaline agent, for example sodium hydroxide.

In one embodiment, the legume flour or legume protein concentrate is mixed with a divalent cation salt after the heating step to form a mixture.

In one embodiment, the divalent cation salt is a magnesium or calcium salt.

In one embodiment, the mixture has a loss factor (tan δ) of between 0.14 and 0.2, a G′ of between 6000 to 8000 Pa, and a G″ of between 1000 and 1500 Pa when measured at 8 wt % protein concentration, at a frequency of 1 Hz, strain of 0.5 and at 30° C. after heating the dispersion to 95° C.; and a moisture content lower than 2.5%; and a water activity (aw) less than 0.6.

In one embodiment, the legume flour or legume protein concentrate before the heating step has a fat range between 15 to 30 wt %, relative to the total wt %, on a moisture free basis.

In one embodiment, the legume flour or legume protein concentrate is derived from soybean, pea, fava, chickpea, or mung bean.

In one embodiment, coloring and/or flavoring is added, for example curcumin, turmeric or beta carotene.

The invention further relates to an egg analogue powder obtained by a method according to the invention.

The invention further relates to an egg analogue powder comprising at least 40% functionalized legume flour or at least 40% functionalized legume protein concentrate.

In one embodiment, the legume flour or legume protein concentrate has a
a. loss factor (tan δ) of between 0.1 and 0.2, a G′ of between 2000 to 8000 Pa, and a G″ of between 400 and 1500 Pa when measured at 8 wt % protein concentration, at a frequency of 1 Hz, strain of 0.5% and at 30° C. after heating a dispersion of the heated legume flour or legume protein concentrate to at least 95° C.; and
b. moisture content lower than 2.5%; and
c. water activity (aw) less than 0.6.

In one embodiment, the legume flour is defatted.

The invention further relates to the use of an egg analogue powder according to the invention as an egg extender or egg replacer for a poultry egg, for example a chicken egg.

In an embodiment, the egg extender has the rheological properties as described herein.

The invention further relates to the use of an egg analogue powder according to the invention as a binder in a meat analogue.

### DETAILED DESCRIPTION

### Legume Flour

Unless stated otherwise, legume flours as described herein are non-defatted. A non-defatted legume flour typically comprises greater than 10% fat, or greater than 20% fat.

When the legume flour is soybean flour, then the flour preferably comprises (a) between 30 to 50% protein, or about 41% protein; and/or (b) between 20 to 30% fat, or about 25% fat; and/or (c) less than 5% carbohydrates, or about 2% carbohydrates; and/or (d) between 5 to 10% moisture, or about 7% moisture.

When the legume flour is defatted soybean flour, then the flour preferably comprises (a) between 40 to 60% protein, or about 50% protein; and/or (b) less than 5% fat, or about 1% fat; and/or (c) between 15 to 25% carbohydrates, or about 20% carbohydrates; and/or (d) between 5 to 10% moisture, or about 8% moisture.

When the legume flour is faba flour, then the flour preferably comprises (a) between 20 to 40% protein, or about 31% protein; and/or (b) less than 5% fat, or about 2% fat; and/or (c) between 45 to 65% carbohydrates, or about 55% carbohydrates; and/or (d) between 10 to 20% moisture, or about 14% moisture.

When the legume flour is pea flour, then the flour preferably comprises (a) between 20 to 30% protein, or about 25% protein; and/or (b) less than 5% fat, or about 2% fat; and/or (c) between 50 to 70% carbohydrates, or about 61% carbohydrates; and/or (d) between 10 to 20% moisture, or about 14% moisture.

When the legume flour is chickpea flour, then the flour preferably comprises (a) between 15 to 25% protein, or about 20% protein; and/or (b) less than 5% fat, or about 1% fat; and/or (c) between 55 to 75% carbohydrates, or about 65% carbohydrates; and/or (d) between 5 to 10% moisture, or about 8% moisture.

In one embodiment, the flour is unrefined flour.

### Legume Protein Concentrate

The preferred legume protein concentrate is soy protein concentrate. When the legume protein concentrate is soy protein concentrate, then the protein concentrate preferably comprises (a) between 55 to 75% protein, or about 63% protein; and/or (b) less than 5% fat, or about 1% fat; and/or (c) less than 2% carbohydrates, or about 0.02% carbohydrates; and/or (d) less than 10% moisture, or about 7% moisture.

In one embodiment, the protein concentrate is used in combination with flour.

### Heating

Heating may be performed using a fluidized bed, an extrusion device, a double jacket mixer, or by convection heating.

### Dry Heating

For dry heating, legume flours or legume protein concentrates are preferably spread to form a layer of less than 5 mm thick, preferably less than 4 mm, preferably less than 3 mm, preferably less than 2 mm, or between 1 mm to 5 mm thick. Preferably, heating is by convection heating, for example in a convection oven.

When the temperature is about 100° C., the heating time is preferably about 30 min. When the temperature is about 120° C., the heating time is preferably about 20 min. When the temperature is about 140° C., the heating time is preferably about 10 min.

Typically, the flour or protein concentrate is allowed to cool down for up to about 2 minutes after heating. Typically, the flour or protein concentrate is transferred to a bag, for example an aluminium bag, and sealed. The legume flour may be defatted.

### Moisture Heating

For moisture heating, the percent water content (% W.C.) of the legume flour or legume protein concentrate is adjusted, for example by adding water. Typically, the % W.C. is adjusted to about 15%, about 20%, or about 25% W.C.

Preferably, the % W.C. is adjusted by adding water during mixing. Care is taken to avoid agglomerate formation. The humidified flour or protein concentrate may then be heated for about 30 min at about 80° C. The humidified flour or protein concentrate may then be spread, for example on a tray such as an aluminium tray, to form a layer of no more than about 4 mm thick.

The flour or protein concentrates are then heated so that they reach a moisture content of less than 2.5%. Typically, heating is by convection heating, for example in a convection oven. The heating temperature may be between 100 to 140° C., for example about 120° C. The heating time may be between 2 to 40 minutes, for example about 15 minutes, or about 20 minutes, or about 35 minutes. The heating temperature and heating time used may be the same as, or approximate to, those shown in Table 2. After heating, the flour or protein concentrate is left to cool down for up to about 2 minutes and transferred to a bag, for example an aluminium bag, and sealed. The legume flour may be defatted.

### Moisture Heating and pH Treatment

Typically, legume flour or legume protein concentrate is mixed whilst alkali, for example NaOH, is added until a pH 7 to 9, for example pH 8, is reached following reconstitution in water before cooking. The amount of alkali, for example NaOH, needed can be diluted water. The flour or protein concentrate produced typically has a moisture content of about 15%.

The humidified flour or protein concentrate samples can be transferred to sealed bags, for example sealed aluminum bags, and treated in an oven, for example at about at 80° C., for about 30 minutes. The flour samples can then be transferred to a plate, for example a steel plate, and dried, for example in an oven. Drying can be for about 15 minutes, or for the length of time required to reach a moisture content less than 2.5%.

The flour or protein concentrate is left to cool down, and then transferred to a bag and sealed without vacuum. The legume flour may be defatted.

### Egg Extender Preparation

Typically, legume flour or legume protein concentrates are left to stabilize after heating, for example in a bag, for at least 24 hours. Flour or protein concentrate are then added to water so that the final protein concentration is about 8%. Preferably, lump formation is avoided. Fresh egg is then typically added. The final protein concentration is typically between 5 to 15%, for example about 11%. Typically, the suspension is sheared for about 5 mins. The legume flour may be defatted.

Mixing with Divalent Ions

The legume flour or legume protein concentrate can be mixed with a divalent cation salt after the heating step to form a mixture. Flour or protein concentrate samples are typically left to stabilize after heat treatment in bags, for example aluminium bags.

Magnesium salt, for example MgCl₂₋₆-hydrate can be added to water and sheared. For example, about 50, 100, 150 and 200 mg of MgCl₂-6-hydrate may be added to, respectively, 39.36, 39.31, 39.26 and 39.21 g of water. Flour or protein concentrate is typically added.

Typically, the final protein concentrations are about 8%. The addition of salt corresponds to respectively about 0.012, 0.024, 0.036 and 0.048% of magnesium.

Calcium salt, for example CaCl₂-6-hydrate can be added to water and sheared. For example, about 50, 100, 150 and 200 mg of CaCl₂-6-hydrate may be added to, respectively, about 39.36, 39.31, 39.26 and 39.21 g of water. Flour or protein concentrate is typically added, so that the final protein concentration is about 8%. The addition of salt corresponds to respectively about 0.027, 0.055, 0.082 and 0.109% of calcium.

The amount of magnesium and calcium salt, for example MgCl₂-6-hydrate and CaCl₂-6-hydrate, and amount of water mixed, can be scaled up.

### Dry Heating Legume Flour

The dry heated legume flour may be derived from, for example, soybean, pea, fava, chickpea, or mung bean. The legume flour may be defatted.

### Use as Egg Replacer

In some embodiments, the product can be used as a replacement for whole eggs, egg yolks, or egg whites in food products. In some embodiments, the food products can be baked goods such as but not limited to cakes, brownies, cookies, pancakes, pastries, pies, tarts, and scones. In some embodiments, the compositions can be used as a replacement for eggs or egg parts in other products such as but not limited to pasta, noodles, meatloaf, custards, sauces, ice cream, mayonnaise, and/or salad dressings.

The product can be used in many culinary applications, for example for aerating (e.g. in sponge cakes, soufflés, pavola), binding (e.g. in omelettes, quenelles), clarifying (e.g. in stocks, consommé soups, aspic), coating (e.g. fried or deep fried foods, such as fish, meats, chicken and vegetables), enriching (e.g. cakes, puddings, pasta, egg-nog drinks), garnishing (e.g. consommé royal, consommé celestine), glazing (e.g. bread and bread rolls, duchesse potatoes), or for thickening (e.g. soups, custards).

### Definitions

When a composition is described herein in terms of wt %, this means a mixture of the ingredients on a moisture free basis, unless indicated otherwise.

As used herein, the term “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range.

As used herein, the term “analogue” is considered to be an edible substitute of a substance in regard to one or more of its major characteristics. An “egg analogue” as used herein is a substitute of egg in the major characteristics of purpose and usage. Preferably, the egg analogue is an analogue of chicken egg.

As used herein, the term “vegan” refers to an edible composition which is entirely devoid of animal products, or animal derived products, for example eggs, milk, honey, fish, and meat.

As used herein, the term “vegetarian” relates to an edible composition which is entirely devoid of meat, poultry, game, fish, shellfish or by-products of animal slaughter.

As used herein, the term polysaccharide relates to a type of carbohydrate. A polysaccharide is a polymer comprising chains of monosaccharides that are joined by glycosidic linkages. Polysaccharides are also known as glycans. By convention, a polysaccharide consists of more than ten monosaccharide units. Polysaccharides may be linear or branched. They may consist of a single type of simple sugar (homopolysaccharides) or two or more sugars (heteropolysaccharides). The main functions of polysaccharides are structural support, energy storage, and cellular communication. Examples of polysaccharides include carrageenan, cellulose, hemicellulose, chitin, chitosan, glycogen, starch, dextrin (starch gum), hyaluronic acid, polysdextrose, inulin, beta-glucan, pectin, psyllium husk mucilage, beta-mannan, carob, fenugreek, guar gum tara gum, konjac gum or glucomannan, gum acacia (arabic), karaya, tragacanth, arabinoxylan, gellan, xanthan, agar, alginate, methylcellulose, carboxymethlylcelulose, hydroxypropyl methylcellulose, microfibrilated cellulose, microcrystalline cellulose.

Those skilled in the art will understand that they can freely combine all features of the present invention disclosed herein. In particular, features described for the compositions of the present invention may be combined with the method or uses of the present invention and vice versa.

Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1

### Flour Functionalization

Soybean flour (full fat and defatted), faba flour, pea flour, and chickpea flours were obtained from commercial sources and had ingredients shown in Table 1.

TABLE 1

| | | | Protein | Fat | | Moisture |
|---|---|---|---|---|---|---|
| | | | content | content | Carbohydrates | content |
| Name | Supplier | Batch | [%] | [%] | [%] | [%] |
| Soybean flour | Arles | 906745 | 40.59 | 24.78 | 2.20 | 6.98 |
| full fat | | | | | (cellulose) | |
| BIOPRO 32 | | | | | | |
| Soybean flour | Arles | 894641 | 50.43 | 1.00 | 20.2 | ≤8 |
| defatted | | | | | (glucides) | |
| BIOPRO 10 L | | | | | | |
| Faba flour F200X | Vestkorn | 943967 | 31.4 | 2.17 | 55.0 | <14 |
| Pea flour F200X | Vestkorn | 943959 | 24.5 | 2.14 | 61.3 | <14 |
| Chickpea flour | AGT Food | 947843 | 20.3 | 1.10 | 64.8 | 8.0 |
| | | | | | (starch) | |
| Soy Concentrate | Dupont | 867885 | 63.1 | 1.17 | 0.02 | 6.91 |
| Alpha 12 | | | | | | |

The functionalized ingredients are measured using rheological methods e.g. small amplitude oscillation.

### Dry Heating (Lab Scale)—Soy Flour Functionalization

Flours were spread onto an aluminum tray to form a thin layer of no more than 3 to 4 mm. A maximum of 150 g of flour was placed in a 40 cm/40 cm metallic plate, for example an aluminium tray. The flours were placed in a convection oven and heat treated at different temperatures and times:
100° C.—30 min
120° C.—20 min
140° C.—10 min

After heat treatment, the flour was taken out of the oven, left for a maximum of 2 minutes to cool down and then transferred to an aluminum bag and sealed without vacuum.

### Moisture-Heating (Lab Scale)—Soy Flour Functionalization

The % water content (% W.C.) of each flour was known from the table above. The amount of water to be added that was required to reach 15%, 20% and 25% W.C. was calculated.

Soy flour (full fat or defatted) was placed into a Thermomixer and the calculated amounts of water were added slowly (over about ˜1 min) at speed 5 to avoid any agglomerates. The flour-water mixtures were mixed for 3 minutes at speed 5. The humidified soy flour was placed in an aluminum bag, sealed, and placed in a convection oven for 30 min at 80° C. The heat treated humidified soy flour was spread onto an aluminum or metallic tray to form a thin layer (no more than 3 to 4 mm).

The aluminum trays were placed in a convection oven and treated at three different temperatures (100/120/140° C.). The drying times were chosen to reach a moisture content below 2.5%:

TABLE 2

| | Drying time | Drying time |
|---|---|---|
| Treatment | Soy full fat | Soy defatted |
| 100° C.-15% | 15′ | 20′ |
| 100° C.-20% | 25′ | 30′ |
| 100° C.-25% | 35′ | 30′ |
| 120° C.-15% | 15′ | NA |
| 120° C.-20% | 15′ | NA |
| 120° C.-25% | 20′ | NA |
| 140° C.-15% | 15′ | NA |
| 140° C.-20% | 15′ | NA |
| 140° C.-25% | 15′ | NA |

After heat treatment, the flour was taken out of the oven, left for a maximum of 2 minutes to cool down and then transferred to an aluminum bag and sealed without vacuum.

### Moisture-Heating and pH Treatment—Soy Flour Functionalization

50 g of full fat soy 32 Arles flour was placed in a thermomixer. Mixing was started at speed 5 and then, drop by drop, the amount of 2 M NaOH necessary to obtain three different samples at pH 7/8/9 following the reconstitution in water before cooking was added. The amount of NaOH needed was diluted with Vittel water so that the flour produced had a moisture content of 15%. After mixing for 3 minutes at speed 5, the thermomixer container was opened, the walls of the container were cleaned, thereby bringing the flour that had deposited on the walls back to the center and mixed for another 3 minutes.

The 15% humidified flour samples were transferred to sealed aluminum bags and treated in an oven at 80° C. for 30 minutes. The flour samples were then transferred to a steel plate and dried in an oven for 15 minutes for the length of time required to reach a moisture content <2.5%.

The flour was taken out of the oven, left for maximum 2 minutes to cool down, and then transferred to an aluminum bag and sealed without vacuum. The flours were then reconstituted in water for rheology analysis.

The quantity of 2 M NaOH added to each of the 3 samples is indicated in table 3:

TABLE 3

| Sample | NaOH 2M added |
|---|---|
| pH 7 | 4.25 g |
| pH 8 | 7.74 g |
| pH 9 | 10.19 g |

### Example 2

### Rheological Measurements

### Sample Preparation

Samples were left to stabilize after heat treatment for at least 24 hours in the sealed aluminum bags. Close to 10.18 g of soy flour (calculated for 8% of proteins) and 39.82 g of water were weighed to reach a total solution of 50 g. The flour was added slowly to the water under fast shear to avoid lumps and ensured dispersal. Shearing of the dispersion was continued for 5 minutes and then the pH was measured. 3 ml of the soy flour dispersion was added to the rheometer.

### Small Amplitude Oscillation Sequence

Oscillatory rheological measurements were carried out to assess the heat-set gelling ability of the flour ingredients, and the extender samples. A resting step of 5 minutes was initially applied to equilibrate the material at 20° C., constant strain of 0.5% and frequency of 1 Hz. The loss and storage modulus were then measured at a frequency of 1 Hz and a strain of 0.5% while heating from 20° C. to 95° C. at a heating rate of 5° C./min, followed by a 5 minute holding at 85° C. and a subsequent cooling step from 95° C. to 7° C. at 4° C./min. A holding step at 7° C. was then applied for 15 minutes (constant strain of 0.5% and frequency of 1 Hz) followed by frequency and amplitude sweep tests at 7° C. During frequency sweeps, the frequency was increased from 0.01 to 10 Hz within 4 minutes at a constant strain of 0.5%. During strain sweeps, the strain was increased from 0.1 to 100% within 4 minutes at a constant frequency of 1 Hz.

### Water Activity Measurements

Samples were left for stabilization after heat treatment for at least 24 hours sealed in aluminum bags. The water activity of samples was measured using the method LI-00.014-02. Water activity analysis was performed for each sample, as it was a key criteria for sample safety release. Water activity (a_{w}), also defined as the equilibrium relative humidity (ERH), measures the vapor pressure at the surface of a product. It is defined as being the relative humidity of a product in equilibrium with its environment when the product is placed in a closed system at a constant temperature. The a_{w} of the samples was measured with Aqualab 4 TEV and 4 TE.

Each sample was placed in a closed measuring cell. The chilled-mirror dew point technique was used to measure the a_{w}. A stainless-steel mirror within the chamber was repeatedly cooled and heated (to provide a Peltier effect) while water contained in the sample was driven off as vapor. Each time dew occurred on the mirror, the sample temperature was measured and then water activity was estimated.

Approximately 3-4 g of sample was homogenously placed in the measuring cup and lodged in the a_{w}-meter chamber. The sample was considered to be in equilibrium when the variation of a_{w} in a time span of 20 min at 25° C. was within an accuracy of ±0.005.

### Water Content Measurements

Samples were left to stabilize after heat treatment for at least 24 hours. The halogen moisture analyzer operates on the thermogravimetric principle. At the start of the measurement, the Moisture Analyzer determined the weight of the sample. A portion of heating flour (3.4-4.6 g) was heated to 140° C. by the halogen dryer unit until constant weight was achieved. The moisture content is calculated from the loss of mass after the heat treatment and expressed in %.

### Color Measurements

In order to quantify the changes in color observed in the flours as consequence of the heat treatment applied to the flours, color analysis was carried out using a spectrometer device (VeriVide Digieye device). In short, 3.5 g of heat treated flours were tested in a 3.5 cm petri dishes placed in an illumination cabinet containing a combination of fluorescent D65 illuminant and additive LEDs. A digital camera was used to capture high quality images of the different flours. Values of a* (the amount of red and green), b* (the amount of yellow and blue), L* (the amount of luminosity from black to white) were recorded in triplicate from three independent samples obtained for each treatment. Total color deviation (ΔE) of each sample was calculated according to the following equation.

$$Δ E = \sqrt{{( {L}_{control}^{*} - {L}_{sample}^{⋆} )}^{2} + {( {a}_{control}^{*} - {a}_{sample}^{*} )}^{2} + {( {b}_{c ontrol}^{*} - {b}_{sample}^{*} )}^{2}}$$

Δ E refers to a measure of the overall color change in the sample.

### Example 3

### Rheological Properties of Plant-Based Egg Extenders Based on Treated Defatted Soybean Flour

### Sample Preparation

SOY flour samples were left to stabilize after heat treatment for at least 24 hours in sealed aluminum bags. Close to 7.93 g of soy flour defatted Biopro 10L (calculated for 8% of proteins) and 42.07 g of water were weighed to reach a total solution of 50 g. The flour was added slowly to the water under fast shear to avoid lumps and ensuring dispersibility.

15 g of fresh egg (corresponds to 3.77% proteins) was added, blended previously for 60 seconds in a Thermomixer. The final solution contains a total of 11.77% protein.

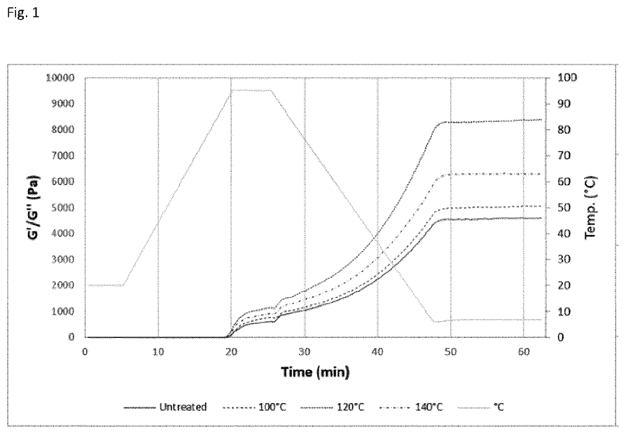

Shearing of the dispersion was continued for 5 minutes and the pH was measured. 3 mL of the soy flour dispersion was added to the rheometer (see FIG. 1).

TABLE 4
G′, G″, tan δ of egg extender samples (11.7% wt. protein concentration)
from frequency sweeps performed at a constant strain of 0.5% within the
LVR and a temperature of 7° C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 6066 | 6690 | 11116 | 8215 | 30269 | 26833 |
| ω = 10 Hz | | | | | | |
| G″ [Pa], | 1273 | 1425 | 2431 | 1750 | 5133 | 5739 |
| ω = 10 Hz | | | | | | |
| tanδ, | 0.21 | 0.21 | 0.22 | 0.21 | 0.17 | 0.21 |
| ω = 10 Hz | | | | | | |

TABLE 5
G′, G″, tan δ of egg extender samples (11.7%
wt. protein concentration) from temperature sweeps performed
at a constant strain of 0.5% within the LVR and a temperature
of 60° C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 1380 | 1511 | 2397 | 1886 | 7678 | 5722 |
| ω = 1 Hz, | | | | | | |
| T = 60° C. | | | | | | |
| G″ [Pa], | 184 | 204 | 336 | 256 | 644 | 606 |
| ω = 1 Hz, | | | | | | |
| T = 60° C. | | | | | | |
| tanδ, | 0.13 | 0.14 | 0.14 | 0.14 | 0.08 | 0.11 |
| ω = 1 Hz, | | | | | | |
| T = 60° C. | | | | | | |

TABLE 6
G′, G″, tanδ of egg extender (samples 11.7% wt. protein concentration)
from temperature sweeps performed at a constant strain of 0.5% within the
LVR and a temperature of 30° C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 2582 | 2804 | 4652 | 3544 | 13095 | 10567 |
| ω = 1 Hz, | | | | | | |
| T = 30° C. | | | | | | |
| G″ [Pa], | 454 | 500 | 847 | 628 | 1766 | 1687 |
| ω = 1 Hz, | | | | | | |
| T = 30° C. | | | | | | |
| tanδ, | 0.18 | 0.18 | 0.18 | 0.18 | 0.14 | 0.16 |
| ω = 1 Hz, | | | | | | |
| T = 30° C. | | | | | | |

### Example 4

### Rheological Properties of Plant-Based Egg Extenders Based on Treated Full Fat Soybean Flour

### Sample Preparation

Soy flour samples were left to stabilize after heat treatment for at least 24 hours in sealed aluminum bags. Close to 10.59 g of soy flour full fat Biopro 32 (calculated for 8% of proteins) and 39.41 g of water were weighed to reach a total solution of 50 g. The flour was added slowly to the water under fast shear to avoid lumps and ensuring dispersibility.

15 g of fresh egg (corresponds to 3.77% proteins) was added, blended previously for 60 seconds in a Thermomixer. The final solution contains a total of 11.77% protein.

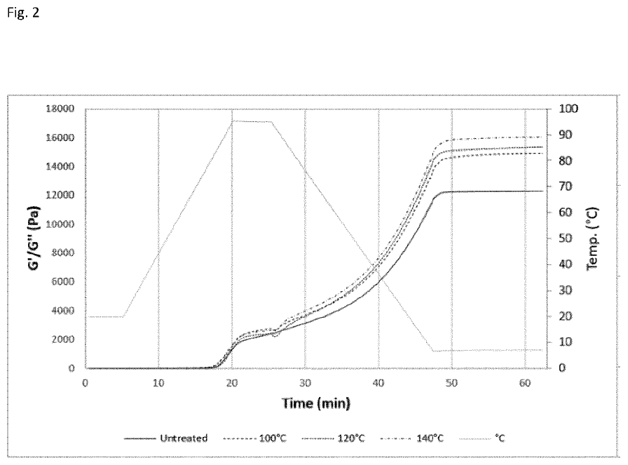

Shearing of the dispersion was continued for 5 minutes and the pH was measured. 3 mL of the soy flour dispersion was added to the rheometer (FIG. 2).

TABLE 7
G′, G″, tan δ of egg extender samples (11.7% wt. protein concentration)
from frequency sweeps performed at a constant strain of 0.5% within the
LVR and a temperature of 7° C., after heating to 95° C., as described herein.

| Soy flour | Un- | | | | Fresh | Egg |
|---|---|---|---|---|---|---|
| full fat | treated | 100° C. | 120° C. | 140° C. | egg | powder |
| G′ [Pa], | 15613 | 18514 | 19607 | 20312 | 30269 | 26833 |
| ω = 10 Hz | | | | | | |
| G″ [Pa], | 3002 | 3362 | 3669 | 3779 | 5133 | 5739 |
| ω = 10 Hz | | | | | | |
| tanδ, | 0.19 | 0.18 | 0.19 | 0.19 | 0.17 | 0.21 |
| ω = 10 Hz | | | | | | |

TABLE 8
G′, G″, tan δ of egg extender samples (11.7%
wt. protein concentration) from temperature sweeps performed
at a constant strain of 0.5% within the LVR and a temperature
of 60° C., after heating to 95° C., as described herein.

| Soy flour | Un- | | | | Fresh | Egg |
|---|---|---|---|---|---|---|
| full fat | treated | 100° C. | 120° C. | 140° C. | egg | powder |
| G′ [Pa], | 3904 | 4599 | 4644 | 4998 | 7678 | 5722 |
| ω = 1 Hz, | | | | | | |
| T = 60° C. | | | | | | |
| G″ [Pa], | 495 | 545 | 605 | 627 | 644 | 606 |
| ω = 1 Hz, | | | | | | |
| T = 60° C. | | | | | | |
| tanδ, | 0.13 | 0.12 | 0.13 | 0.13 | 0.08 | 0.11 |
| ω = 1 Hz, | | | | | | |
| T = 60° C. | | | | | | |

TABLE 9
G′, G″, tanδ of egg extender samples (11.7% wt. protein concentration)
from temperature sweeps performed at a constant strain of 0.5% within the
LVR and a temperature of 30° C., after heating to 95° C., as described herein.

| Soy flour | Un- | | | | Fresh | Egg |
|---|---|---|---|---|---|---|
| full fat | treated | 100° C. | 120° C. | 140° C. | egg | powder |
| G′ [Pa], | 6848 | 8071 | 8388 | 8796 | 13095 | 10567 |
| ω = 1 Hz, | | | | | | |
| T = 30° C. | | | | | | |
| G″ [Pa], | 1180 | 1323 | 1453 | 1493 | 1766 | 1687 |
| ω = 1 Hz, | | | | | | |
| T = 30° C. | | | | | | |
| tanδ, | 0.17 | 0.16 | 0.17 | 0.17 | 0.14 | 0.16 |
| ω = 1 Hz, | | | | | | |
| T = 30° C. | | | | | | |

### Example 5

### Rheological Properties of Treated (Dry Heating) Defatted Soybean Flour

### Sample Preparation

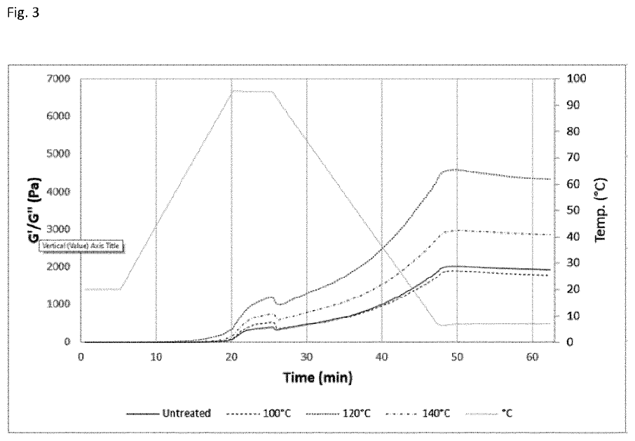

Soy flour samples were left to stabilize after heat treatment for at least 24 hours in the sealed aluminum bags. Close to 7.93 g of soy flour defatted Biopro 10L (calculated for 8% of proteins) and 42.07 g of water were weighed to reach a total solution of 50 g. The flour was added slowly to the water under fast shear to avoid lumps and ensuring dispersibility. Shearing the dispersion was continued for 5 minutes and the pH was measured. 3 mL of the soy flour dispersion was added to the rheometer (FIG. 3).

TABLE 10
G′, G″, tanδ of soy flour samples (8% wt. protein
concentration) from frequency sweeps performed at a constant
strain of 0.5% within the LVR and a temperature of 7°
C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 2438 | 2193 | 5333 | 3524 | 8447 | 6854 |
| ω = 10 Hz | | | | | | |
| G″ [Pa], | 588 | 543 | 1216 | 843 | 1328 | 1422 |
| ω = 10 Hz | | | | | | |
| tanδ, | 0.24 | 0.25 | 0.23 | 0.24 | 0.16 | 0.21 |
| ω = 10 Hz | | | | | | |

TABLE 11
G′, G″, tanδ of soy flour samples (8% wt. protein
concentration) from temperature sweeps performed at a
constant strain of 0.5% within the LVR and a temperature
of 60° C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 626 | 612 | 1636 | 1005 | 2206 | 1835 |
| ω = 1 Hz, | | | | | | |
| T = 60° C. | | | | | | |
| G″ [Pa], | 98 | 97 | 235 | 140 | 183 | 158 |
| ω = 1 Hz, | | | | | | |
| T = 60° C. | | | | | | |
| tanδ, | 0.16 | 0.16 | 0.14 | 0.14 | 0.08 | 0.09 |
| ω = 1 Hz, | | | | | | |
| T = 60° C. | | | | | | |

TABLE 12
G′, G″, tan δ of soy flour samples (8% wt.
protein concentration) from temperature sweeps performed
at a constant strain of 0.5% within the LVR and a temperature
of 30° C., after heating to 95° C., as described herein.

| Soy flour | | | | | | |
|---|---|---|---|---|---|---|
| defatted | Un- | | | | Fresh | Egg |
| 10 L | treated | 100° C. | 120° C. | 140° C. | egg | powder |
| G′ [Pa], | 1150 | 1092 | 2799 | 1738 | 3817 | 2993 |
| ω = 1 Hz, | | | | | | |
| T = 30° C. | | | | | | |
| G″ [Pa], | 212 | 202 | 484 | 300 | 495 | 418 |
| ω = 1 Hz, | | | | | | |
| T = 30° C. | | | | | | |
| tanδ, | 0.19 | 0.19 | 0.17 | 0.17 | 0.13 | 0.14 |
| ω = 1 Hz, | | | | | | |
| T = 30° C. | | | | | | |

### Example 6

### Water Activity, Moisture Content and Color Change of Treated (Dry Heating) Defatted Soybean Flour

TABLE 13
water activity and moisture

| Soy flour | | 100° | 120° | 140° |
|---|---|---|---|---|
| defatted 10 L | Untreated | C. | C. | C. |
| Water activity | 0.334 | 0.051 | 0.026 | 0.035 |
| Moisture | 7.19 (0.06) | 2.59 (0.13) | 1.43 (0.03) | 1.77 (0.04) |
| content, % | | | | |
| (standard | | | | |
| deviation) | | | | |
| Digi-Eye (ΔE), | — | 0.48 (0.18) | 0.69 (0.21) | 0.81 (0.13) |
| (standard | | | | |
| deviation) | | | | |

### Example 7

### Rheological Properties of Treated (Dry Heating) Full Fat Soybean Flour

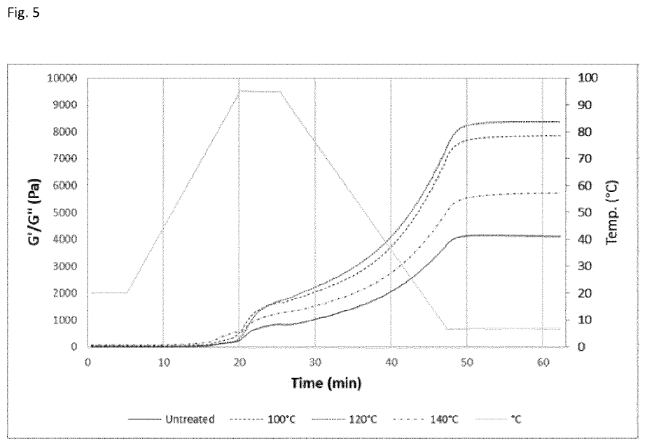

Soy flour samples were left for stabilization after heat treatment for at least 24 hours in the sealed aluminum bags. Close to 10.59 g of soy flour full fat Biopro 32 (calculated for 8% of proteins) and 39.41 g of water were weighed to reach a total solution of 50 g. The flour was added slowly to the water under fast shear to avoid lumps, ensuring dispersibility. Shearing of the dispersion was continued for 5 minutes and pH was measured. 3 mL of the soy flour dispersion was added to the rheometer (FIG. 5).

TABLE 14
G′, G″, tanδ of soy flour samples (8% wt. protein concentration)
from frequency sweeps performed at a constant strain of 0.5% within the
LVR and a temperature of 7° C., after heating to 95° C., as described herein.

| Soy flour full fat | Untreated | 100° C. | 120° C. | 140° C. | Fresh egg | Egg powder |
|---|---|---|---|---|---|---|
| G′ [Pa], ω = 10 Hz | 5210 | 9964 | 10562 | 7312 | 8447 | 6854 |
| G″ [Pa], ω = 10 Hz | 1042 | 2008 | 2144 | 1487 | 1328 | 1422 |
| tanδ, ω = 10 Hz | 0.20 | 0.20 | 0.20 | 0.20 | 0.16 | 0.21 |

TABLE 15
G′, G″, tanδ of soy flour samples (8% wt. protein concentration)
from temperature sweeps performed at a constant strain of 0.5% within the
LVR and a temperature of 60° C., after heating to 95° C., as described herein.

| Soy flour full fat | Untreated | 100° C. | 120° C. | 140° C. | Fresh egg | Egg powder |
|---|---|---|---|---|---|---|
| G′ [Pa], ω = 1 Hz, | 1344 | 2501 | 2771 | 1869 | 2206 | 1835 |
| T = 60° C. | | | | | | |
| G″ [Pa], ω = 1 Hz, | 201 | 379 | 410 | 283 | 183 | 158 |
| T = 60° C. | | | | | | |
| tanδ, ω = 1 Hz, | 0.15 | 0.15 | 0.15 | 0.15 | 0.08 | 0.09 |
| T = 60° C. | | | | | | |

TABLE 16
G′, G″, tanδ of soy flour samples (8% wt. protein concentration)
from temperature sweeps performed at a constant strain of 0.5% within the
LVR and a temperature of 30° C., after heating to 95° C., as described herein.

| Soy flour full fat | Untreated | 100° C. | 120° C. | 140° C. | Fresh egg | Egg powder |
|---|---|---|---|---|---|---|
| G′ [Pa], ω = 1 Hz, | 2331 | 4226 | 4615 | 3098 | 3817 | 2993 |
| T = 30° C. | | | | | | |
| G″ [Pa], ω = 1 Hz, | 417 | 781 | 836 | 570 | 495 | 418 |
| T = 30° C. | | | | | | |
| tanδ, ω = 1 Hz, | 0.18 | 0.19 | 0.18 | 0.18 | 0.13 | 0.14 |
| T = 30° C. | | | | | | |

### Example 8

### Moisture Content and Color Change of Treated (Dry Heating) Full Fat Soybean Flour

TABLE 17
water activity and moisture

| Soy flour | | 100° | 120° | 140° |
|---|---|---|---|---|
| full fat | Untreated | C. | C. | C. |
| Moisture | 7.30 (0.01) | 1.59 (0.11) | 2.24 (0.06) | 1.28 (0.01) |
| content, % | | | | |
| (standard | | | | |
| deviation) | | | | |
| Digi-Eye (ΔE), | — | 0.99 (0.25) | 2.11 (0.77) | 1.45 (0.83) |
| (standard | | | | |
| deviation) | | | | |

### Example 9

### Rheological Properties of Treated (Moisture-Heated) Defatted Soybean Flour Sample Preparation

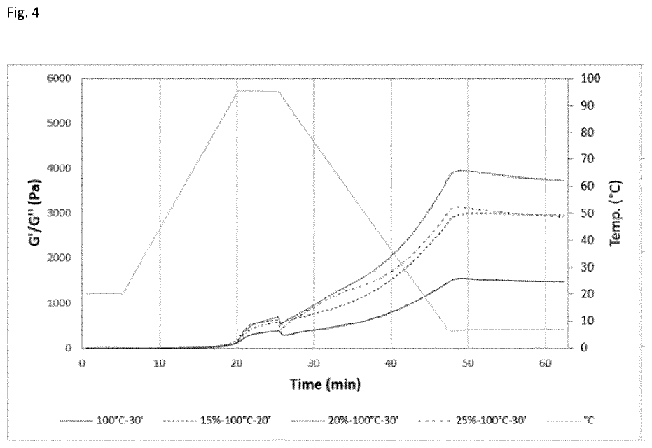

The treated soy flour samples were left for stabilization after the humidification and dry heat treatment for at least 24 hours in the sealed aluminum bags. Close to 7.93 g of soy flour defatted Biopro 10L (calculated for 8% of proteins) and 42.07 g of water were weighed to reach a total solution of 50 g. The flour was added slowly to the water under fast shear to avoid lumps, ensuring dispersibility. Shearing of the dispersion was continued for 5 minutes and the pH was measured. 3 mL of the soy flour dispersion was added to the rheometer (FIG. 4).

TABLE 18
G′, G″, tanδ of soy flour samples (8% wt. protein concentration)
from frequency sweeps performed at a constant strain of 0.5% within the
LVR and a temperature of 7° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour defatted 10 L | Untreated | 100° C. | 20′ | 30′ | 30′ | egg | powder |
| G′ [Pa], ω = 10 Hz | 2438 | 2193 | 3688 | 4685 | 3719 | 8447 | 6854 |
| G″ [Pa], ω = 10 Hz | 588 | 543 | 809 | 1037 | 906 | 1328 | 1422 |
| tanδ, ω = 10 Hz | 0.24 | 0.25 | 0.22 | 0.22 | 0.24 | 0.16 | 0.21 |

TABLE 19
G′, G″, tanδ of soy flour samples (8% wt. protein concentration)
from temperature sweeps performed at a constant strain of 0.5% within the
LVR and a temperature of 60° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour defatted 10 L | Untreated | 100° C. | 20′ | 30′ | 30′ | egg | powder |
| G′ [Pa], ω = 1 Hz, | 626 | 612 | 962 | 1342 | 1250 | 2206 | 1835 |
| T = 60° C. | | | | | | | |
| G″ [Pa], ω = 1 Hz, | 98 | 97 | 136 | 209 | 212 | 183 | 158 |
| T = 60° C. | | | | | | | |
| tanδ, ω = 1 Hz, | 0.16 | 0.16 | 0.14 | 0.15 | 0.17 | 0.08 | 0.09 |
| T = 60° C. | | | | | | | |

TABLE 20
G′, G″, tanδ of soy flour samples (8% wt. protein concentration)
from temperature sweeps performed at a constant strain of 0.5% within the
LVR and a temperature of 30° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour defatted 10 L | Untreated | 100° C. | 20′ | 30′ | 30′ | egg | powder |
| G′ [Pa], ω = 1 Hz, | 1150 | 1092 | 1725 | 2315 | 1906 | 3817 | 2993 |
| T = 30° C. | | | | | | | |
| G″ [Pa], ω = 1 Hz, | 212 | 202 | 296 | 410 | 356 | 495 | 418 |
| T = 30° C. | | | | | | | |
| tanδ, ω = 1 Hz, | 0.19 | 0.19 | 0.17 | 0.18 | 0.19 | 0.13 | 0.14 |
| T = 30° C. | | | | | | | |

### Example 10

### Water Activity, Moisture Content and Color Change of Treated (Dry Heating) Defatted Soybean Flour

TABLE 21
water activity and moisture

| Soy flour | | 15% 100° | 20% 100° | 25% 100° |
|---|---|---|---|---|
| defatted 10 L | Untreated | C. 20′ | C. 30′ | C. 30′ |
| Water activity | 0.334 | 0.034 | 0.027 | 0.048 |
| Moisture | 7.19 (0.06) | 2.11 (0.01) | 1.83 (0.30) | 2.08 (0.45) |
| content, % | | | | |
| (standard | | | | |
| deviation) | | | | |
| Digi-Eye (ΔE), | — | 4.18 (0.24) | 7.00 (0.65) | 11.34 (0.96) |
| (standard | | | | |
| deviation) | | | | |

### Example 11

### Rheological Properties of Treated (Moistured-Heated) Full Fat Soybean Flour

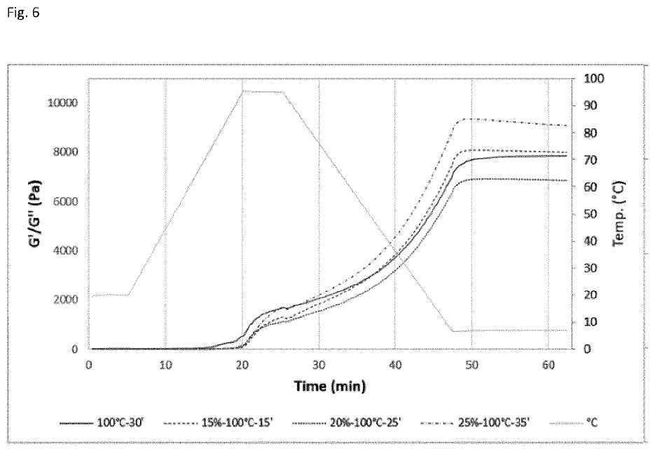

The treated soy flour samples were left for stabilization after the humidification and dry heat treatment for at least 24 hours in the sealed aluminum bags. Close to 10.59 g of soy flour full fat Biopro 32 (calculated for 8% of proteins) and 39.41 g of water was weighed to reach a total solution of 50 g. The flour was added slowly to the water under fast shear to avoid lumps, ensuring dispersibility. Shearing of the dispersion was continued for 5 minutes and the pH was measured. 3 mL of the soy flour dispersion was added to the rheometer (FIG. 6).

TABLE 22
G′, G″, tanδ of soy flour samples (8% wt. protein concentration)
from frequency sweeps performed at a constant strain of 0.5% within the
LVR and a temperature of 7° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour full fat | Untreated | 100° C. | 15′ | 25′ | 35′ | egg | powder |
| G′ [Pa], ω = 10 Hz | 5210 | 9964 | 10257 | 8827 | 11734 | 8447 | 6854 |
| G″ [Pa], ω = 10 Hz | 1042 | 2008 | 2125 | 1836 | 2414 | 1328 | 1422 |
| tanδ, ω = 10 Hz | 0.20 | 0.20 | 0.21 | 0.21 | 0.21 | 0.16 | 0.21 |

TABLE 23
G′, G″, tanδ of soy flour samples (8% wt. protein concentration)
from temperature sweeps performed at a constant strain of 0.5% within the
LVR and a temperature of 60° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour full fat | Untreated | 100° C. | 15′ | 25′ | 35′ | egg | powder |
| G′ [Pa], ω = 1 Hz, | 1344 | 2501 | 2415 | 2009 | 2860 | 2206 | 1835 |
| T = 60° C. | | | | | | | |
| G″ [Pa], ω = 1 Hz, | 201 | 379 | 363 | 307 | 426 | 183 | 158 |
| T = 60° C. | | | | | | | |
| tanδ, ω = 1 Hz, | 0.15 | 0.15 | 0.15 | 0.15 | 0.15 | 0.08 | 0.09 |
| T = 60° C. | | | | | | | |

TABLE 24
G′, G″, tanδ of soy flour samples (8% wt. protein concentration)
from temperature sweeps performed at a constant strain of 0.5% within the
LVR and a temperature of 30° C., after heating to 95° C., as described herein.

| | | | 15% | 20% | 25% | | |
|---|---|---|---|---|---|---|---|
| | | | 100° C. | 100° C. | 100° C. | Fresh | Egg |
| Soy flour full fat | Untreated | 100° C. | 15′ | 25′ | 35′ | egg | powder |
| G′ [Pa], ω = 1 Hz, | 2331 | 4226 | 4401 | 3680 | 5249 | 3817 | 2993 |
| T = 30° C. | | | | | | | |
| G″ [Pa], ω = 1 Hz, | 417 | 781 | 813 | 688 | 943 | 495 | 418 |
| T = 30° C. | | | | | | | |
| tanδ, ω = 1 Hz, | 0.18 | 0.19 | 0.19 | 0.19 | 0.18 | 0.13 | 0.14 |
| T = 30° C. | | | | | | | |

### Example 12

### Water Activity, Moisture Content and Color Change of Treated (Dry Heating) Full Fat Soybean Flour

TABLE 25
water activity and moisture

| Soy flour | | 15% 100° | 20% 100° | 25% 100° |
|---|---|---|---|---|
| full fat | Untreated | C. 15′ | C. 25′ | C. 35′ |
| Water activity | 0.328 | 0.059 | 0.070 | 0.067 |
| Moisture | 7.30 (0.01) | 2.20 (0.06) | 2.01 (0.37) | 2.38 (0.33) |
| content, % | | | | |
| (standard | | | | |
| deviation) | | | | |
| Digi-Eye (ΔE), | — | 6.54 (0.20) | 13.57 (0.46) | 20.50 (0.38) |
| (standard | | | | |
| deviation) | | | | |

### Example 13

### Rheological Properties of NaOH-Treated (Moisture-Heated) Full Fat Soybean Flour

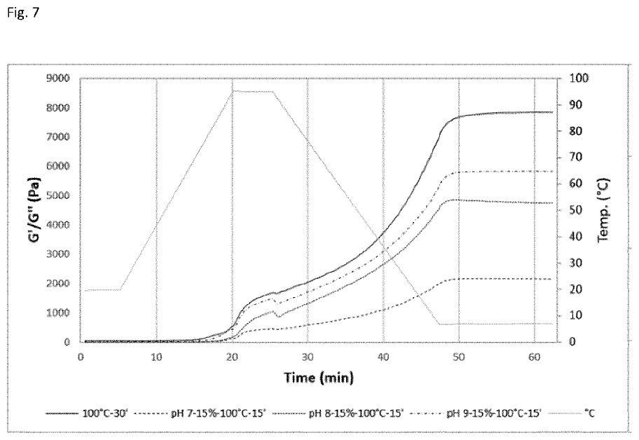

The NaOH treated soy flour samples were left for stabilization after the humidification and dry heat treatment for at least 24 hours in the sealed aluminum bags. Close to 10.59 g of soy flour full fat Biopro 32 (calculated for 8% of proteins) and 39.41 g of water was weighed to reach a total solution of 50 g. The flour was added slowly to the water under fast shear to avoid lumps, ensuring dispersibility. Shearing of the dispersion was continued for 5 minutes and the pH was measured. 3 mL of the soy flour dispersion was added to the rheometer (FIG. 7).

TABLE 26
G′, G″, tanδ of soy flour samples (8% wt. protein concentration)
from frequency sweeps performed at a constant strain of 0.5% within the
LVR and a temperature of 7° C., after heating to 95° C., as described herein.

| | | | pH 7 | pH 8 | pH 9 | | |
|---|---|---|---|---|---|---|---|
| | | | 15% | 15% | 15% | | |
| | | | 100° C. | 100° C. | 100° C. | Fresh | Egg |
| Soy flour full fat | Untreated | 100° C. | 15′ | 15′ | 15′ | egg | powder |
| G′ [Pa], ω = 10 Hz | 5210 | 9964 | 2732 | 5089 | 7352 | 8447 | 6854 |
| G″ [Pa], ω = 10 Hz | 1042 | 2008 | 563 | 979 | 1443 | 1328 | 1422 |
| tanδ, ω = 10 Hz | 0.20 | 0.20 | 0.21 | 0.19 | 0.20 | 0.16 | 0.21 |

TABLE 27
G′, G″, tanδ of soy flour samples (8% wt. protein concentration)
from temperature sweeps performed at a constant strain of 0.5% within the
LVR and a temperature of 60° C., after heating to 95° C., as described herein.

| | | | pH 7 | pH 8 | pH 9 | | |
|---|---|---|---|---|---|---|---|
| | | | 15% | 15% | 15% | | |
| | | | 100° C. | 100° C. | 100° C. | Fresh | Egg |
| Soy flour full fat | Untreated | 100° C. | 15′ | 15′ | 15′ | egg | powder |
| G′ [Pa], ω = 1 Hz, | 1344 | 2501 | 757 | 1531 | 2164 | 2206 | 1835 |
| T = 60° C. | | | | | | | |
| G″ [Pa], ω = 1 Hz, | 201 | 379 | 116 | 229 | 326 | 183 | 158 |
| T = 60° C. | | | | | | | |
| tanδ, ω = 1 Hz, | 0.15 | 0.15 | 0.15 | 0.15 | 0.15 | 0.08 | 0.09 |
| T = 60° C. | | | | | | | |

TABLE 28
G′, G″, tanδ of soy flour samples (8% wt. protein concentration)
from temperature sweeps performed at a constant strain of 0.5% within the
LVR and a temperature of 30° C., after heating to 95° C., as described herein.

| | | | pH 7 | pH 8 | pH 9 | | |
|---|---|---|---|---|---|---|---|
| | | | 15% | 15% | 15% | | |
| | | | 100° C. | 100° C. | 100° C. | Fresh | Egg |
| Soy flour full fat | Untreated | 100° C. | 15′ | 15′ | 15′ | egg | powder |
| G′ [Pa], ω = 1 Hz, | 2331 | 4226 | 1243 | 2501 | 3442 | 3817 | 2993 |
| T = 30° C. | | | | | | | |
| G″ [Pa], ω = 1 Hz, | 417 | 781 | 229 | 434 | 610 | 495 | 418 |
| T = 30° C. | | | | | | | |
| tanδ, ω = 1 Hz, | 0.18 | 0.19 | 0.19 | 0.17 | 0.18 | 0.13 | 0.14 |
| T = 30° C. | | | | | | | |

### Example 14

### Water Activity, Moisture Content and Color Change of Treated (Dry Heating) Full Fat Soybean Flour

TABLE 29
water activity and moisture

| Soy flour | | pH 7 15% | pH 8 15% | pH 9 15% |
|---|---|---|---|---|
| full fat | Untreated | 100° C. 15′ | 100° C. 15′ | 100° C. 15′ |
| Water activity | 0.328 | 0.109 | 0.037 | 0.142 |
| Moisture | 7.30 (0.01) | 3.37 (0.23) | 1.86 (0.02) | 3.23 (0.05) |
| content, % | | | | |
| (standard | | | | |
| deviation) | | | | |
| Digi-Eye (ΔE), | — | 7.80 (0.05) | 5.78 (0.40) | 6.78 (0.64) |
| (standard | | | | |
| deviation) | | | | |

### Example 15

### Rheological Properties of Treated (Dry Heating) Full Fat Soybean Flour Containing Different Concentration of Magnesium Chloride Salt.

Soy flour samples were left for stabilization after heat treatment for at least 24 hours in the sealed aluminum bags. 50, 100, 150 and 200 mg of MgCl₂-6-hydrate were added to respectively to 39.36, 39.31, 39.26 and 39.21 g of water and sheared for 1 minutes on a magnetic stirrer to dissolve the salt. To each of the MgCl₂-water solution was added 10.59 g of soy flour full fat Biopro 32 (calculated for 8% of proteins) to reach a total solution of 50 g. The flour was added slowly to the water under fast shear to avoid lumps, ensuring dispersibility. Shearing of the dispersion was continued for 5 minutes and pH was measured. 3 mL of the soy flour dispersion was added to the rheometer.

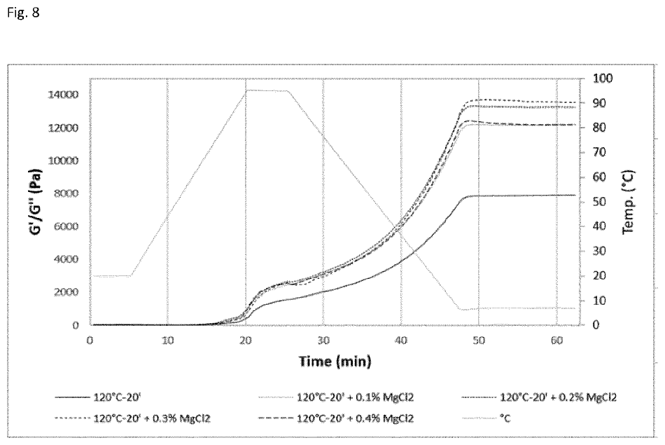

The addition of salt corresponds to respectively 0.012, 0.024, 0.036 and 0.048% of magnesium (FIG. 8).

TABLE 30
G′, G″, tanδ of soy flour samples (8% wt. protein concentration) at a range
of MgCl₂ concentration from frequency sweeps performed at a constant strain of 0.5%
within the LVR and a temperature of 7° C., after heating to 95° C., as described herein.

| Soy flour | | 120° C.- | +0.1% | +0.2% | +0.3% | +0.4% | Fresh | Egg |
|---|---|---|---|---|---|---|---|---|
| full fat | Untreated | 20′ | MgCl₂ | MgCl2 | MgCl₂ | MgCl₂ | egg | powder |
| G′ [Pa], ω = 10 Hz | 5210 | 10562 | 15540 | 16206 | 16147 | 14266 | 8447 | 6854 |
| G″ [Pa], ω = 10 Hz | 1042 | 2144 | 3498 | 3586 | 3463 | 3039 | 1328 | 1422 |
| tanδ, ω = 10 Hz | 0.20 | 0.20 | 0.23 | 0.22 | 0.21 | 0.21 | 0.16 | 0.21 |

TABLE 31
G′, G″, tanδ of soy flour samples (8% wt. protein concentration) at a range
of MgCl₂ concentration from temperature sweeps performed at a constant strain of 0.5%
within the LVR and a temperature of 60° C., after heating to 95° C., as described herein.

| | | 120° C.- | +0.1% | +0.2% | +0.3% | +0.4% | Fresh | Egg |
|---|---|---|---|---|---|---|---|---|
| Soy flour full fat | Untreated | 20′ | MgCl₂ | MgCl₂ | MgCl₂ | MgCl₂ | egg | powder |
| G′ [Pa], ω = 1 Hz, | 1344 | 2771 | 3921 | 4069 | 3843 | 3858 | 2206 | 1835 |
| T = 60° C. | | | | | | | | |
| G″ [Pa], ω = 1 Hz, | 201 | 410 | 571 | 519 | 448 | 422 | 183 | 158 |
| T = 60° C. | | | | | | | | |
| tanδ, ω = 1 Hz, | 0.15 | 0.15 | 0.15 | 0.13 | 0.12 | 0.11 | 0.08 | 0.09 |
| T = 60° C. | | | | | | | | |

TABLE 32
G′, G″, tanδ of soy flour samples (8% wt. protein concentration) at a range
of MgCl₂ concentration from temperature sweeps performed at a constant strain of 0.5%
within the LVR and a temperature of 30° C., after heating to 95° C., as described herein.

| | | 120° C.- | +0.1% | +0.2% | +0.3% | +0.4% | Fresh | Egg |
|---|---|---|---|---|---|---|---|---|
| Soy flour full fat | Untreated | 20′ | MgCl₂ | MgCl₂ | MgCl₂ | MgCl₂ | egg | powder |
| G′ [Pa], ω = 1 Hz, | 2331 | 4615 | 6856 | 7354 | 7228 | 6883 | 3817 | 2993 |
| T = 30° C. | | | | | | | | |
| G″ [Pa], ω = 1 Hz, | 417 | 836 | 1282 | 1273 | 1221 | 1093 | 495 | 418 |
| T = 30° C. | | | | | | | | |
| tanδ, ω = 1 Hz, | 0.18 | 0.18 | 0.19 | 0.17 | 0.17 | 0.16 | 0.13 | 0.14 |
| T = 30° C. | | | | | | | | |

### Example 16

### Rheological Properties of Treated (Dry Heating) Full Fat Soybean Flour Containing Different Concentration of Calcium Chloride Salt.

Soy flour samples were left for stabilization after heat treatment for at least 24 hours in the sealed aluminum bags. 50, 100, 150 and 200 mg of CaCl₂-6-hydrate were added to respectively to 39.36, 39.31, 39.26 and 39.21 g of water and sheared for 1 minutes on a magnetic stirrer to dissolve the salt. To each of the CaCl₂-water solution was added 10.59 g of soy flour full fat Biopro 32 (calculated for 8% of proteins) to reach a total solution of 50 g. The flour was added slowly to the water under fast shear to avoid lumps, ensuring dispersibility. Shearing of the dispersion was continued for 5 minutes and pH was measured. 3 mL of the soy flour dispersion was added to the rheometer.

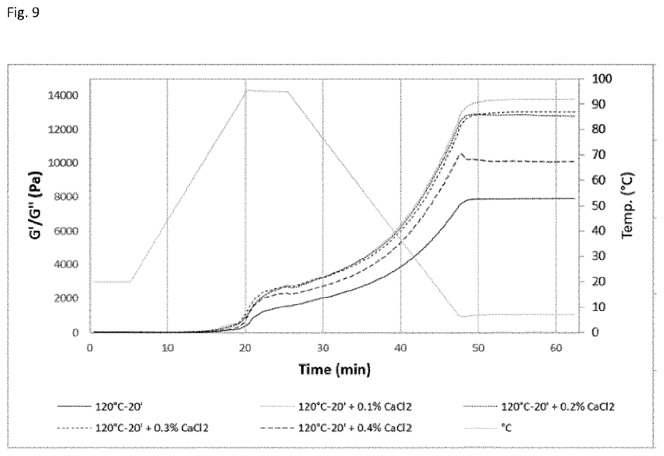

The addition of salt corresponds to respectively 0.027, 0.055, 0.082 and 0.109% of calcium (FIG. 9).

TABLE 33
G′, G″, tanδ of soy flour samples (8% wt. protein concentration) at a range of CaCl₂
concentration from frequency sweeps performed at a constant strain of 0.5% within
the LVR and a temperature of 7° C., after heating to 95° C., as described herein.

| | | | +0.1% | +0.2% | +0.3% | +0.4% | Fresh | Egg |
|---|---|---|---|---|---|---|---|---|
| Soy flour full fat | Untreated | 120° C.-20′ | CaCl₂ | CaCl₂ | CaCl₂ | CaCl₂ | egg | powder |
| G′ [Pa], ω = 10 Hz | 5210 | 10562 | 16948 | 14792 | 15158 | 11337 | 8447 | 6854 |
| G″ [Pa], ω = 10 Hz | 1042 | 2144 | 3474 | 3186 | 3003 | 2447 | 1328 | 1422 |
| tanδ, ω = 10 Hz | 0.20 | 0.20 | 0.21 | 0.22 | 0.20 | 0.22 | 0.16 | 0.21 |

TABLE 34
G′, G″, tanδ of soy flour samples (8% wt. protein concentration) at a range of CaCl₂
concentration from temperature sweeps performed at a constant strain of 0.5% within
the LVR and a temperature of 60° C., after heating to 95° C., as described herein.

| | | | +0.1% | +0.2% | +0.3% | +0.4% | Fresh | Egg |
|---|---|---|---|---|---|---|---|---|
| Soy flour full fat | Untreated | 120° C.-20′ | CaCl₂ | CaCl₂ | CaCl₂ | CaCl₂ | egg | powder |
| G′ [Pa], ω = 1 Hz, | 1344 | 2771 | 4086 | 4057 | 3949 | 3400 | 2206 | 1835 |
| T = 60° C. | | | | | | | | |
| G″ [Pa], ω = 1 Hz, | 201 | 410 | 525 | 453 | 422 | 470 | 183 | 158 |
| T = 60° C. | | | | | | | | |
| tanδ, ω = 1 Hz, | 0.15 | 0.15 | 0.13 | 0.11 | 0.11 | 0.14 | 0.08 | 0.09 |
| T = 60° C. | | | | | | | | |

TABLE 35
G′, G″, tanδ of soy flour samples (8% wt. protein concentration) at a range of CaCl₂
concentration from temperature sweeps performed at a constant strain of 0.5% within
the LVR and a temperature of 30° C., after heating to 95° C., as described herein.

| | | | +0.1% | +0.2% | +0.3% | +0.4% | Fresh | Egg |
|---|---|---|---|---|---|---|---|---|
| Soy flour full fat | Untreated | 120° C.-20′ | CaCl₂ | CaCl₂ | CaCl₂ | CaCl₂ | egg | powder |
| G′ [Pa], ω = 1 Hz, | 2331 | 4615 | 7293 | 7179 | 6857 | 6117 | 3817 | 2993 |
| T = 30° C. | | | | | | | | |
| G″ [Pa], ω = 1 Hz, | 417 | 836 | 1231 | 1151 | 1051 | 1210 | 495 | 418 |
| T = 30° C. | | | | | | | | |
| tanδ, ω = 1 Hz, | 0.18 | 0.18 | 0.17 | 0.16 | 0.15 | 0.20 | 0.13 | 0.14 |
| T = 30° C. | | | | | | | | |

### Example 17

### Rheological Properties of Treated (Dry Heating) Faba Bean Flour Sample Preparation

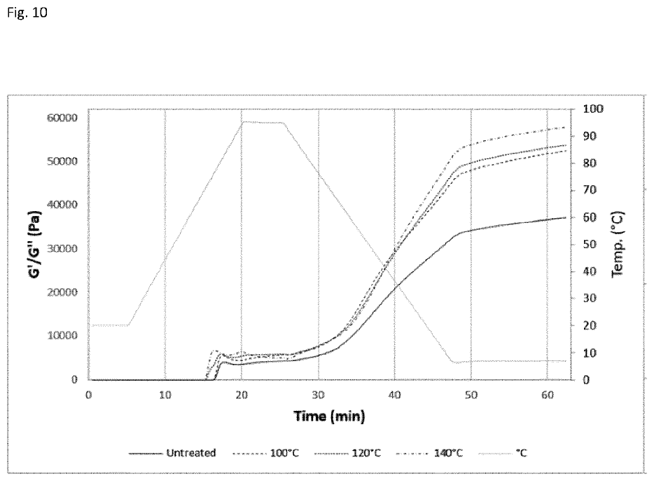

The faba bean flour samples were left to stabilize after heat treatment for at least 24 hours in the sealed aluminum bags. Close to 12.74 g of faba bean flour F200X (calculated for 8% of proteins) and 37.27 g of water were weighed to reach a total solution of 50 g. The flour was added slowly to the water under fast shear to avoid lumps and ensuring dispersibility. Shearing the dispersion was continued for 5 minutes and the pH was measured. 3 mL of the soy flour dispersion was added to the rheometer (FIG. 10).

TABLE 36
G′, G″, tanδ of faba bean flour samples (8% wt. protein concentration)
from frequency sweeps performed at a constant strain of 0.5% within
the LVR and a temperature of 7° C., after heating to 95° C., as
described herein.

| Faba bean | Un- | | | | Fresh | Egg |
|---|---|---|---|---|---|---|
| flour | treated | 100° C. | 120° C. | 140° C. | egg | powder |
| G′ [Pa], | 44277 | 63257 | 64556 | 68817 | 8447 | 6854 |
| ω = 10 Hz | | | | | | |
| G″ [Pa], | 6257 | 9127 | 9001 | 9494 | 1328 | 1422 |
| ω = 10 Hz | | | | | | |
| tanδ, | 0.14 | 0.14 | 0.14 | 0.14 | 0.16 | 0.21 |
| ω = 10 Hz | | | | | | |

TABLE 37
G′, G″, tanδ of faba bean flour samples (8% wt. protein concentration)
from temperature sweeps performed at a constant strain of 0.5% within
the LVR and a temperature of 60° C., after heating to 95° C., as
described herein.

| Faba bean | Un- | | | | Fresh | Egg |
|---|---|---|---|---|---|---|
| flour | treated | 100° C. | 120° C. | 140° C. | egg | powder |
| G′ [Pa], | 9319 | 13059 | 12397 | 11910 | 2206 | 1835 |
| ω = 1 Hz, | | | | | | |
| T = 60° C. | | | | | | |
| G″ [Pa], | 864 | 1166 | 1195 | 1269 | 183 | 158 |
| ω = 1 Hz, | | | | | | |
| T = 60° C. | | | | | | |
| tanδ, | 0.09 | 0.09 | 0.10 | 0.11 | 0.08 | 0.09 |
| ω = 1 Hz, | | | | | | |
| T = 60° C. | | | | | | |

TABLE 38
G′, G″, tanδ of faba bean flour samples (8% wt. protein concentration)
from temperature sweeps performed at a constant strain of 0.5% within
the LVR and a temperature of 30° C., after heating to 95° C., as
described herein.

| Faba bean | Un- | | | | Fresh | Egg |
|---|---|---|---|---|---|---|
| flour | treated | 100° C. | 120° C. | 140° C. | egg | powder |
| G′ [Pa], | 23573 | 32881 | 33065 | 34862 | 3817 | 2993 |
| ω = 1 Hz, | | | | | | |
| T = 30° C. | | | | | | |
| G″ [Pa], | 2377 | 3298 | 3424 | 3665 | 495 | 418 |
| ω = 1 Hz, | | | | | | |
| T = 30° C. | | | | | | |
| tanδ, | 0.10 | 0.10 | 0.10 | 0.11 | 0.13 | 0.14 |
| ω = 1 Hz, | | | | | | |
| T = 30° C. | | | | | | |

### Example 18

### Water Activity and Moisture Content of Treated (Dry Heating) Faba Bean Flour

TABLE 39
water activity and moisture

| Faba bean flour | Untreated | 100° C. | 120° C. | 140° C. |
|---|---|---|---|---|
| Water activity | 0.379 | 0.028 | 0.017 | 0.028 |
| Moisture | 9.44 (0.11) | 0.63 (0.04) | 1.02 (0.04) | 1.76 (0.01) |
| content, % | | | | |
| (standard | | | | |
| deviation) | | | | |

### Example 19

### Rheological Properties of Treated (Dry Heating) Pea Flour

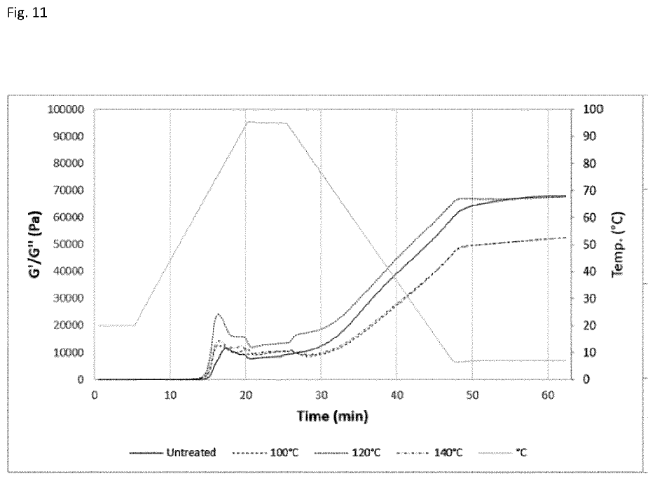

The pea flour samples were left to stabilize after heat treatment for at least 24 hours in the sealed aluminum bags. Close to 16.33 g of pea flour F200X (calculated for 8% of proteins) and 33.68 g of water were weighed to reach a total solution of 50 g. The flour was added slowly to the water under fast shear to avoid lumps and ensuring dispersibility. Shearing the dispersion was continued for 5 minutes and the pH was measured. 3 mL of the soy flour dispersion was added to the rheometer (FIG. 11).

TABLE 40
G′, G″, tanδ of pea flour samples (8% wt. protein concentration)
from frequency sweeps performed at a constant strain of 0.5% within
the LVR and a temperature of 7° C., after heating to 95° C., as
described herein.

| | Un- | | | | Fresh | Egg |
|---|---|---|---|---|---|---|
| Pea flour | treated | 100° C. | 120° C. | 140° C. | egg | powder |
| G′ [Pa], | 69205 | 54231 | 70118 | 55339 | 8447 | 6854 |
| ω = 10 Hz | | | | | | |
| G″ [Pa], | 11915 | 10292 | 11471 | 10360 | 1328 | 1422 |
| ω = 10 Hz | | | | | | |
| tanδ, | 0.17 | 0.19 | 0.19 | 0.20 | 0.16 | 0.21 |
| ω = 10 Hz | | | | | | |

TABLE 41
G′, G″, tanδ of pea flour samples (8% wt. protein concentration)
from frequency sweeps performed at a constant strain of 0.5% within
the LVR and a temperature of 60° C., after heating to 95° C., as
described herein.

| | Un- | | | | Fresh | Egg |
|---|---|---|---|---|---|---|
| Pea flour | treated | 100° C. | 120° C. | 140° C. | egg | powder |
| G′ [Pa], | 21228 | 14300 | 26772 | 14953 | 2206 | 1835 |
| ω = 1 Hz, | | | | | | |
| T = 60° C. | | | | | | |
| G″ [Pa], | 2160 | 1619 | 3061 | 1622 | 183 | 158 |
| ω = 1 Hz, | | | | | | |
| T = 60° C. | | | | | | |
| tanδ, | 0.10 | 0.11 | 0.11 | 0.11 | 0.08 | 0.09 |
| ω = 1 Hz, | | | | | | |
| T = 60° C. | | | | | | |

TABLE 42
G′, G″, tanδ of pea bean flour samples (8% wt. protein concentration)
from temperature sweeps performed at a constant strain of 0.5% within
the LVR and a temperature of 30° C., after heating to 95° C., as
described herein.

| | Un- | | | | Fresh | Egg |
|---|---|---|---|---|---|---|
| Pea flour | treated | 100° C. | 120° C. | 140° C. | egg | powder |
| G′ [Pa], | 43423 | 31224 | 49203 | 31666 | 3817 | 2993 |
| ω = 1 Hz, | | | | | | |
| T = 30° C. | | | | | | |
| G″ [Pa], | 4657 | 3652 | 5474 | 3599 | 495 | 418 |
| ω = 1 Hz, | | | | | | |
| T = 30° C. | | | | | | |
| tanδ, | 0.11 | 0.12 | 0.11 | 0.12 | 0.13 | 0.14 |
| ω = 1 Hz, | | | | | | |
| T = 30° C. | | | | | | |

### Example 20

### Water Activity and Moisture Content of Treated (Dry Heating) Pea Flour

TABLE 43
water activity and moisture

| Pea flour | Untreated | 100° C. | 120° C. | 140° C. |
|---|---|---|---|---|
| Water activity | 0.413 | 0.027 | 0.017 | 0.028 |
| Moisture | 10.56 (0.08) | 0.90 (0.02) | 0.22 (0.21) | 1.00 (0.04) |
| content, % | | | | |
| (standard | | | | |
| deviation) | | | | |

### Example 21

### Rheological Properties of Treated (Dry Heating) Chickpea Flour

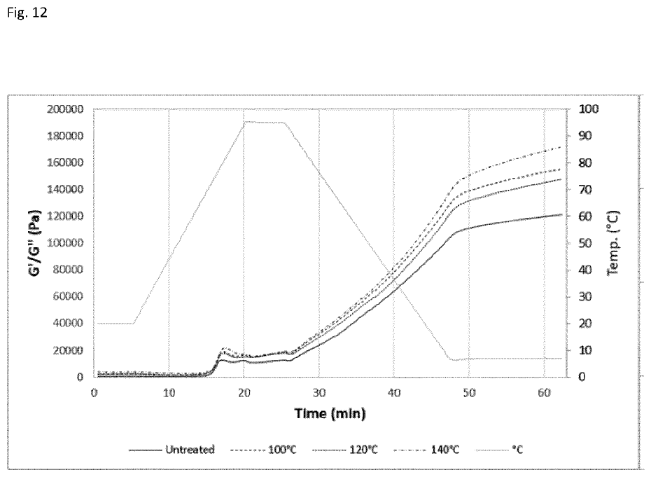

The chickpea flour samples were left to stabilize after heat treatment for at least 24 hours in the sealed aluminum bags. Close to 19.70 g of chickpea flour (calculated for 8% of proteins) and 30.30 g of water were weighed to reach a total solution of 50 g. The flour was added slowly to the water under fast shear to avoid lumps and ensuring dispersibility. Shearing the dispersion was continued for 5 minutes and the pH was measured. 3 mL of the soy flour dispersion was added to the rheometer (FIG. 12).

TABLE 44
G′, G″, tanδ of chickpea flour samples (8% wt. protein concentration)
from frequency sweeps performed at a constant strain of 0.5% within
the LVR and a temperature of 7° C., after heating to 95° C., as
described herein.

| Chickpea | Un- | | | | Fresh | Egg |
|---|---|---|---|---|---|---|
| flour | treated | 100° C. | 120° C. | 140° C. | egg | powder |
| G′ [Pa], | 140710 | 184320 | 176135 | 205475 | 8447 | 6854 |
| ω = 10 Hz | | | | | | |
| G″ [Pa], | 19486 | 24571 | 23861 | 27627 | 1328 | 1422 |
| ω = 10 Hz | | | | | | |
| tanδ, | .014 | 0.13 | 0.14 | 0.13 | 0.16 | 0.21 |
| ω = 10 Hz | | | | | | |

TABLE 45
G′, G″, tanδ of chickpea flour samples (8% wt. protein concentration)
from frequency sweeps performed at a constant strain of 0.5% within
the LVR and a temperature of 60° C., after heating to 95° C., as
described herein.

| Chickpea | Un- | | | | Fresh | Egg |
|---|---|---|---|---|---|---|
| flour | treated | 100° C. | 120° C. | 140° C. | egg | powder |
| G′ [Pa], | 38004 | 48820 | 45419 | 50984 | 2206 | 1835 |
| ω = 1 Hz, | | | | | | |
| T = 60° C. | | | | | | |
| G″ [Pa], | 3723 | 4785 | 4507 | 5081 | 183 | 158 |
| ω = 1 Hz, | | | | | | |
| T = 60° C. | | | | | | |
| tanδ, | 0.10 | 0.10 | 0.10 | 0.10 | 0.08 | 0.09 |
| ω = 1 Hz, | | | | | | |
| T = 60° C. | | | | | | |

TABLE 46
G′, G″, tanδ of chickpea flour samples (8% wt. protein concentration)
from frequency sweeps performed at a constant strain of 0.5% within
the LVR and a temperature of 30° C., after heating to 95° C., as
described herein.

| Chickpea | Un- | | | | Fresh | Egg |
|---|---|---|---|---|---|---|
| flour | treated | 100° C. | 120° C. | 140° C. | egg | powder |
| G′ [Pa], | 72114 | 88278 | 82025 | 92191 | 3817 | 2993 |
| ω = 1 Hz, | | | | | | |
| T = 30° C. | | | | | | |
| G″ [Pa], | 7611 | 9347 | 8794 | 9917 | 495 | 418 |
| ω = 1 Hz, | | | | | | |
| T = 30° C. | | | | | | |
| tanδ, | 0.11 | 0.11 | 0.11 | 0.11 | 0.13 | 0.14 |
| ω = 1 Hz, | | | | | | |
| T = 30° C. | | | | | | |

### Example 22

### Water Activity and Moisture Content of Treated (Dry Heating) Chickpea Flour

TABLE 47
water activity and moisture

| Chickpea flour | Untreated | 100° C. | 120° C. | 140° C. |
|---|---|---|---|---|
| Water activity | 0.241 | 0.012 | 0.011 | 0.008 |
| Moisture | 5.20 (0.04) | 1.23 (0.01) | 0.92 (0.11) | 1.02 (0.15) |
| content, % | | | | |
| (standard | | | | |
| deviation) | | | | |

### Example 23

### Rheological Properties of Treated (Dry Heating) Soy Concentrate Alpha 12

### Sample Preparation

The soy concentrate samples were left to stabilize after heat treatment for at least 24 hours in the sealed aluminum bags. Close to 6.34 g of soy concentrate Alpha 12 (calculated for 8% of proteins) and 43.66 g of water were weighed to reach a total solution of 50 g. The concentrate was added slowly to the water under fast shear to avoid lumps and ensuring dispersibility.

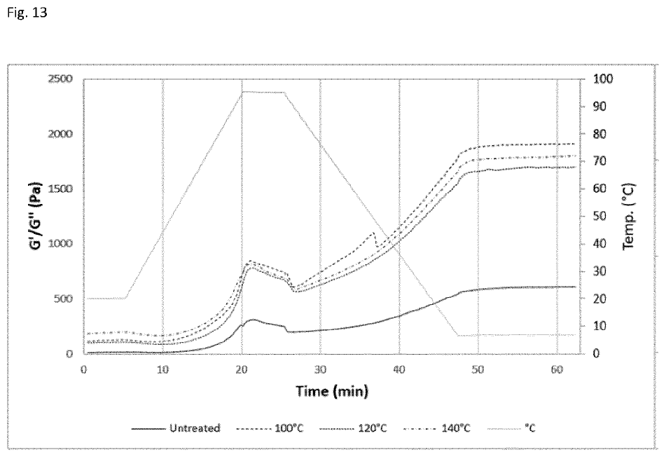

Shearing the dispersion was continued for 5 minutes and the pH was measured. 3 mL of the soy flour dispersion was added to the rheometer (FIG. 13).

TABLE 48
G′, G″, tanδ of soy concentrate samples (8% wt. protein concentration)
from frequency sweeps performed at a constant strain of 0.5% within
the LVR and a temperature of 7° C., after heating to 95° C., as
described herein.

| Soy | | | | | | |
|---|---|---|---|---|---|---|
| concentrate | Un- | | | | Fresh | Egg |
| Alpha 12 | treated | 100° C. | 120° C. | 140° C. | egg | powder |
| G′ [Pa], | 773 | 2410 | 2167 | 2313 | 8447 | 6854 |
| ω = 10 Hz | | | | | | |
| G″ [Pa], | 162 | 429 | 404 | 419 | 1328 | 1422 |
| ω = 10 Hz | | | | | | |
| tanδ, | 0.21 | 0.18 | 0.19 | 0.18 | 0.16 | 0.21 |
| ω = 10 Hz | | | | | | |

TABLE 49
G′, G″, tanδ of soy concentrate samples (8% wt. protein concentration)
from frequency sweeps performed at a constant strain of 0.5% within
the LVR and a temperature of 60° C., after heating to 95° C., as
described herein.

| Soy | | | | | | |
|---|---|---|---|---|---|---|
| concentrate | Un- | | | | Fresh | Egg |
| Alpha 12 | treated | 100° C. | 120° C. | 140° C. | egg | powder |
| G′ [Pa], | 243 | 914 | 746 | 791 | 2206 | 1835 |
| ω = 1 Hz, | | | | | | |
| T = 60° C. | | | | | | |
| G″ [Pa], | 35 | 162 | 108 | 117 | 183 | 158 |
| ω = 1 Hz, | | | | | | |
| T = 60° C. | | | | | | |
| tanδ, | 0.14 | 0.17 | 0.15 | 0.15 | 0.08 | 0.09 |
| ω = 1 Hz, | | | | | | |
| T = 60° C. | | | | | | |

TABLE 50
G′, G″, tanδ of soy concentrate samples (8% wt. protein concentration)
from frequency sweeps performed at a constant strain of 0.5% within
the LVR and a temperature of 30° C., after heating to 95° C., as
described herein.

| Soy | | | | | | |
|---|---|---|---|---|---|---|
| concentrate | Un- | | | | Fresh | Egg |
| Alpha 12 | treated | 100° C. | 120° C. | 140° C. | egg | powder |
| G′ [Pa], | 383 | 1275 | 1130 | 1203 | 3817 | 2993 |
| ω = 1 Hz, | | | | | | |
| T = 30° C. | | | | | | |
| G″ [Pa], | 64 | 213 | 190 | 205 | 495 | 418 |
| ω = 1 Hz, | | | | | | |
| T = 30° C. | | | | | | |
| tanδ, | 0.17 | 0.17 | 0.17 | 0.17 | 0.13 | 0.14 |
| ω = 1 Hz, | | | | | | |
| T = 30° C. | | | | | | |

### Example 24

### Water Activity and Moisture Content of Treated (Dry Heating) Soy Concentrate

TABLE 51
water activity and moisture

| Soy concentrate | | 100° | 120° | 140° |
|---|---|---|---|---|
| Alpha 12 | Untreated | C. | C. | C. |
| Water activity | 0.344 | 0.031 | 0.027 | 0.020 |
| Moisture | 8.90 | 1.63 | 2.016 | 1.36 |
| content, % | (0.10) | (0.03) | (0.03) | (0.00) |
| (standard | | | | |
| deviation) | | | | |

1. A method of making an egg analogue powder, said method comprising heating a legume flour to a temperature between 100 to 140° C., wherein the legume flour is preferably a soybean flour, and wherein the legume flour after the heating step has a
a. loss factor (tan δ) of between 0.1 and 0.2, a G′ of between 1000 to 8000 Pa, and a G″ of between 200 and 1500 Pa when measured at 8 wt % protein concentration, at a frequency of 1 Hz, strain of 0.5% and at 30° C. after heating a dispersion of the heated legume flour to at least 95° C.; and
b. moisture content lower than 2.5%; and
c. water activity (aw) less than 0.6.

2. The method according to claim 1, wherein the heating step has a duration of between 2 to 40 minutes.

3. The method according to claim 1, wherein the legume flour before the heating step comprises between 15 to 35% fat and between 30 to 50% protein, and wherein the flour after the heating step has a loss factor (tan δ) of 0.18, a G′ of between 2000 to 2500 Pa, and a G″ of between 400 and 800 Pa when measured at 8 wt % protein concentration, at a frequency of 1 Hz, strain of 0.5% and at 30° C. after heating a dispersion of the heated legume flour to at least 95° C.

4. The method according to claim 1, wherein the defatted legume flour before the heating step comprises less than 5% fat, and between 40 and 60% protein and wherein the flour after the heating step has a loss factor (tan δ) of 0.19, a G′ of between 1000 to 1500 Pa, and a G″ of between 200 and 300 Pa when measured at 8 wt % protein concentration, at a frequency of 1 Hz, strain of 0.5% and at 30° C. after heating a dispersion of the heated legume flour to at least 95° C.

5. The method according to claim 1, said method further comprising the steps:
a. Adding water to the legume flour, and mixing to form a hydrated flour so that it has a moisture content of 10 to 25% before the heating step; and
b. Performing the heating step by heating the hydrated flour to a temperature between 100° C. to 140° C.; wherein the legume flour after the heating step has a loss factor (tan δ) of between 0.15 and 0.2, a G′ of between 1000 to 4000 Pa, and a G″ of between 200 and 800 Pa when measured at 8 wt % protein concentration, at a frequency of 1 Hz, strain of 0.5% and at 30° C. after heating the dispersion to 95° C.; and a moisture content lower than 2.5%; and a water activity (aw) less than 0.6.

6. The method according to claim 5, wherein the heating step is convection heating.

7. The method according to claim 6, wherein the pH of the water is adjusted to between 7 to 8 by adding an alkaline agent.

8. The method according to claim 1, wherein the legume flour is mixed with a divalent cation salt, for example a magnesium or calcium salt, after the heating step to form a mixture with a loss factor (tan δ) of between 0.14 and 0.2, a G′ of between 6000 to 8000 Pa, and a G″ of between 1000 and 1500 Pa when measured at 8 wt % protein concentration, at a frequency of 1 Hz, strain of 0.5 and at 30° C. after heating the dispersion to 95° C.; and a moisture content lower than 2.5%; and a water activity (aw) less than 0.6.

9. The method according to claim 1, wherein the legume flour before the heating step has a fat range between 15 to 30 wt %, relative to the total wt %, on a moisture free basis.

10. The method according to claim 1, wherein the legume flour is derived from soybean.

11. The method according to claim 1, wherein coloring and/or flavoring is added.

12. (canceled)

13. An egg analogue powder comprising at least 40% functionalized legume flour, wherein the legume flour has a:
a. loss factor (tan δ) of between 0.1 and 0.2, a G′ of between 2000 to 8000 Pa, and a G″ of between 400 and 1500 Pa when measured at 8 wt % protein concentration, at a frequency of 1 Hz, strain of 0.5% and at 30° C. after heating a dispersion of the heated legume flour to at least 95° C.; and
b. moisture content lower than 2.5%; and
c. water activity (aw) less than 0.6.

14-15. (canceled)
